(19) United States
(12) Patent Application Publication
(10) Pub. No.: US 2024/0006681 A1
(43) Pub. Date: Jan. 4, 2024

(54) BATTERY SYSTEM WITH THERMAL RUNAWAY STABILITY

(71) Applicant: HYUNDAI MOBIS CO., LTD., Seoul (KR)

(72) Inventor: Yong Jung KIM, Anyang-si (KR)

(73) Assignee: HYUNDAI MOBIS CO., LTD., Seoul (KR)

(21) Appl. No.: 18/216,854

(22) Filed: Jun. 30, 2023

(30) Foreign Application Priority Data
Jul. 1, 2022 (KR) 10-2022-0081077

(51) Int. Cl. H01M 10/6554; H01M 10/653; H01M 10/48; H01M 50/264; H01M 50/244

(52) U.S. Cl. CPC H01M 10/6554; H01M 10/653; H01M 10/486; H01M 50/264; H01M 50/244

(57) ABSTRACT

The present invention relates to a battery system, and more particularly, to a battery system having improved stability and practicality. The battery system with thermal runaway stability according to the present invention is capable of efficiently cooling a battery module, by applying a frame bent in a U shape to the battery module, so that a thermally conductive filler can be applied to both upper and lower sides of the battery module.

### CROSS-REFERENCE TO RELATED APPLICATIONS

This application claims priority under 35 U.S.C. § 119 to Korean Patent Application No. 10-2022-0081077, filed on Jul. 1, 2022, in the Korean Intellectual Property Office, the disclosure of which is incorporated herein by reference in its entirety.

### TECHNICAL FIELD

The following disclosure relates to a battery system, and more particularly, to a battery system having improved stability and practicality.

### BACKGROUND

Secondary batteries, which are easy to apply according to product groups and have electrical characteristics such as high energy density, are commonly applied not only to portable devices but also to electric or hybrid vehicles driven by electrical driving sources, power storage devices, and the like. These secondary batteries are attracting attention as a new energy source for improving eco-friendliness and energy efficiency because they do not generate any by-products as a result of using the energy as well as the primary advantage in that the use of fossil fuels can be dramatically reduced.

However, medium or large devices such as automobiles require high power and large capacity, whereas small mobile devices use one to four battery cells per device. Therefore, the medium or large devices use medium or large battery modules in which a plurality of battery cells are electrically connected to each other.

The medium or large battery modules are preferably manufactured to have as small of a size and weight as possible. Therefore, prismatic battery cells, pouch-type battery cells, or the like, which can be stacked with a high degree of integration and have a small weight-to-capacity ratio, are mainly used as battery cells for the medium or large battery modules. Meanwhile, the battery module may include a frame member of which front and rear sides are open to accommodate a battery cell stack in an internal space thereof in order to protect the cell stack from external shock, heat, or vibration.

In this case, in order to support the battery cell stack, a number of parts including the frame member are applied to an upper side of the battery cell stack, making it difficult to apply a structure for cooling the entire battery cell stack. For this reason, only a lower portion of the battery cell is cooled in the prior art, resulting in very low efficiency in controlling a temperature of a battery cell.

In addition, since the plurality of battery cells are stacked, when the temperature of one of the battery cells rises above a certain level, an adjacent battery cell is affected by the rise of the temperature and thermal runaway occurs therein. The frame member protecting the battery cell stack causes a rise in internal pressure during the thermal runaway, leading to an explosion of the battery cell stack. The prior art has a problem in that stability against such an explosion is very low.

Furthermore, in order to prevent the thermal runaway of the battery cell stack, a cell monitoring unit (CMU) for monitoring a voltage and a temperature of the battery cell stack is required. In the prior art, as the CMU of the battery cell stack is provided separately, there is a problem that it is difficult to immediately monitor each battery cell, resulting in low efficiency in inspecting and repairing the battery cell.

### PRIOR ART DOCUMENT

### Patent Document

Korean Patent Laid-Open Publication No. 10-2020-0144423 entitled “BATTERY MODULE AND BATTERY PACK INCLUDING THE SAME”

### SUMMARY

An embodiment of the present invention is directed to providing a battery system with thermal runaway stability capable of efficiently cooling a battery module, by applying a frame bent in a U shape to the battery module, so that a thermally conductive filler can be applied to both upper and lower sides of the battery module.

Another embodiment of the present invention is directed to providing a battery system with thermal runaway stability capable of minimizing exposure of a problem to the outside of the system when the problem occurs in a battery cell, by sealing all of the six surfaces of the battery cell.

Another embodiment of the present invention is directed to providing a battery system with thermal runaway stability capable of minimizing heat generation and minimizing transfer of heat to an adjacent battery cell even though heat is generated, by applying a cooling plate and a heat-resistant pad between cells.

Another embodiment of the present invention is directed to providing a battery system with thermal runaway stability capable of minimizing transfer of heat to an adjacent battery cell even if thermal runaway occurs in any battery cell, by forming a partition wall on a sensing PCB in which voltage and temperature sensing circuits are mounted.

Another embodiment of the present invention is directed to providing a battery system with thermal runaway stability capable of immediately monitoring a voltage state and a temperature state of a battery module so that the battery module can be repaired at any time, by mounting a cell monitoring unit (CMU) in contact with an outer surface of a housing of a battery pack.

In one general aspect, a battery system with thermal runaway stability includes: a battery module in which one or more cell assemblies are stacked in a predetermined stacking direction, each of the cell assemblies including two battery cells and a cooling plate sandwiched between the two battery cells; a support frame bent in a U shape while one side and the other side thereof are open to be coupled to three surfaces of the battery module; and a heat conductor applied to at least one side surface of the battery module.

The support frame may include: two lateral surface coupling portions coupled to surfaces of the battery module perpendicular to the stacking direction; and an upper surface coupling portion connecting the lateral surface coupling portions to each other and coupled to one surface of the battery module.

The heat conductor may include: a first heat conductor applied to a side surface of the battery module that is not in contact with the support frame; and a second heat conductor applied between the upper surface coupling portion and the battery module.

The battery system may further include a heat-resistant pad sandwiched between every two adjacent ones of the cell assemblies.

The support frame may include at least one anti-swelling groove formed in an inward direction on each surface thereof.

The battery system may further include an end plate disposed between each of the lateral surface coupling portions and the battery module.

The end plate may include a wire harness extending in a direction in which the support frame is open, and circuits measuring a voltage and a temperature of the battery module may be integrated in the wire harness.

The battery system may further include a clamp additionally supporting the coupling of the battery module to the support frame, wherein both end portions of the clamp are perpendicularly bent by a predetermined length, and the both end portions of the clamp are fixed to the lateral surface coupling portions, respectively, and the clamp is in contact with a side surface of the battery module that is not in contact with the support frame.

The battery system may further include a sensing unit coupled to one side and the other side of the support frame to sense information of the battery module, wherein the sensing unit includes: a front side assembly coupled to one side of the support frame, with a sensing terminal mounted thereon; and a rear side assembly coupled to the other side of the support frame, with a sensing terminal mounted thereon, each of the front side assembly and the rear side assembly includes at least one partition wall protruding toward the battery module, and the partition wall is located between every two adjacent ones of the cell assemblies.

The battery system may further include a cover unit coupled to one side and the other side of the support frame to support the battery module, wherein the cover unit includes a pair of cover housings coupled to one side and the other side of the support frame, one end of each of the cover housings is open, and the other end of each of the cover housings is closed, and the cover housing includes a plurality of coupling surfaces surrounding one end and the other end of the cover housing and coupled to the support frame.

At least one of the coupling surfaces of the cover housing may be tilted in an outward direction so that the cover housing has a predetermined angle of 90 degrees or more between the other end surface and the at least one of the coupling surfaces thereof.

The cover housing may have at least one discharge groove formed on an outer or inner side of each of the coupling surfaces.

The battery system may further include a control unit receiving voltage information or temperature information of the battery module and controlling the battery module, wherein the cover housing further includes a mounting means on an outer surface thereof to mount the control unit thereon.

The control unit may include a voltage sensing wire connected to a sensing unit, and a communication hole through which the voltage sensing wire passes may be formed in the other end surface of the cover housing.

The cover housing may have at least one wireless communication groove formed in the other end surface or one of the coupling surfaces thereof to assist wireless communication between the control unit and the sensing unit.

In the battery system with thermal runaway stability having the above-described configuration according to the present invention, by applying the frame bent in a U shape to the battery module so that the thermally conductive filler can be applied to both upper and lower sides of the battery module, the battery module can be efficiently cooled.

In addition, by sealing all of the six surfaces of the battery cell, when a problem occurs in the battery cell, exposure of the problem to the outside of the system can be minimized.

In addition, by applying the cooling plate and the heat-resistant pad between the cells, heat generation can be minimized, and transfer of heat to an adjacent battery cell can be minimized even though heat is generated.

In addition, by forming the partition wall on the sensing PCB in which the voltage and temperature sensing circuits are mounted, even if thermal runaway occurs in any battery cell, transfer of heat to an adjacent battery cell can be minimized.

In addition, by mounting the CMU in contact with the outer surface of the housing of the battery pack, a voltage state and a temperature state of the battery module can be immediately monitored so that the battery module can be repaired at any time.

### BRIEF DESCRIPTION OF THE DRAWINGS

FIG. 1 is an exploded perspective view of a battery system with thermal runaway stability according to the present invention.

FIG. 2 is a partially enlarged view illustrating a battery module and its specific configuration according to the present invention.

FIG. 3 is an exploded perspective view illustrating a coupling relationship of a support frame with the battery module according to the present invention.

FIG. 4 is a schematic view illustrating a method of heat exchange of the battery module according to the present invention.

FIGS. 5 and 6 are plan views illustrating a front side assembly of a sensing unit according to the present invention.

FIGS. 7 and 8 are plan views illustrating a rear side assembly of the sensing unit according to the present invention.

FIG. 9 is a perspective view illustrating a cover unit according to the present invention.

FIG. 10 is a cross-sectional view illustrating a coupling relationship between the cover unit and the support frame according to the present invention.

FIG. 11 is a plan view illustrating a control unit and a mounting means according to the present invention.

### DETAILED DESCRIPTION OF MAIN ELEMENTS

1000: Battery system with thermal runaway stability
100: Battery module
110: Cell assembly
111: Battery cell
112: Cooling plate
120: Heat-resistant pad
200: Support frame
210: Lateral surface coupling portion
220: Upper surface coupling portion
230: Anti-swelling groove
300: Heat conductor
400: End plate
410: Wire harness
500: Clamp
600: Sensing unit
610: Front side assembly
620: Rear side assembly
630: Partition wall
640: +/−terminal block
650: Sensing terminal
660: Connector
700: Cover unit
710: Cover housing
711: Coupling surface
712: Mounting means
713: Communication hole
800: Control unit
810: Voltage sensing wire

### DETAILED DESCRIPTION OF EMBODIMENTS

Hereinafter, the technical idea of the present invention will be described in more detail with reference to the accompanying drawings. Further, terms or words used in the specification and claims herein should not be interpreted as being limited to the ordinary or dictionary meanings, but interpreted as meanings and concepts corresponding to the technical idea of the present invention based on the principle that the inventor can appropriately define concepts of terms to describe his/her invention in the best way.

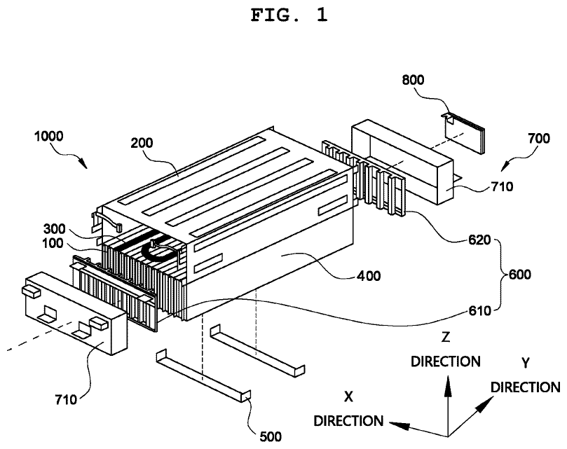

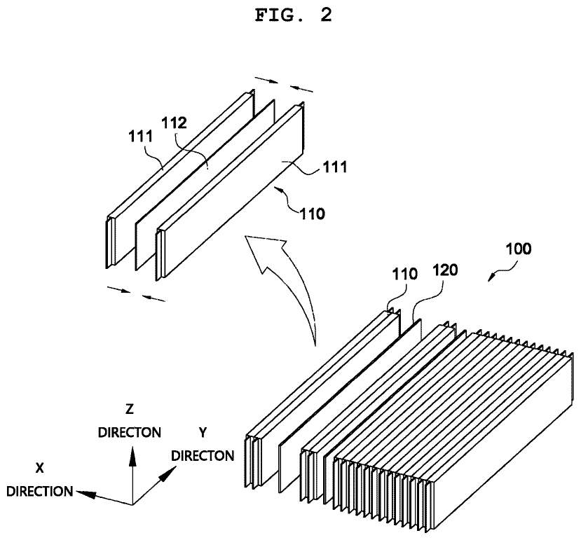

Hereinafter, a basic configuration of a battery system 1000 with thermal runaway stability according to the present invention will be described with reference to FIGS. 1 and 2. As illustrated in FIG. 1, the battery system 1000 with thermal runaway stability according to the present invention may include a battery module 100 and a support frame 200 supporting the battery module 100. More specifically, as illustrated in FIG. 2, the battery module 100 according to the present invention may include a plurality of cell assemblies 110. The battery module 100 according to the present invention may be formed by stacking the cell assemblies 110 in a predetermined stacking direction, each of the cell assemblies 110 including two battery cells 111 and a straight cooling plate 112 sandwiched between the two battery cells 111. In this case, by additionally providing a heat-resistant pad 120 sandwiched between every two adjacent ones of the cell assemblies 110, even if thermal runaway occurs in any one of the cell assemblies 110, it is possible to minimize the transfer of heat to the cell assemblies 110 close thereto.

In addition, the support frame 200 according to the present invention is preferably bent in a U shape while one side and the other side thereof are open to be coupled to three of the surfaces of the battery module 100. More specifically, by perpendicularly bending a flat plate twice, the bent plate may be combined with the three surfaces of the battery module 100 that continuously adjoin each other. In this case, the surfaces of the battery module 100 coupled to the support frame 200 are preferably one (hereinafter referred to as an upper and lower surface) of the surfaces parallel to the plane formed in the X and Y directions of FIG. 1 and the two surfaces (hereinafter referred to as lateral surfaces) parallel to the plane formed in the Z and Y directions of FIG. 1. In this case, it is preferable that electrodes of each battery cell 111 are located on surfaces parallel to the plane formed in the Z and X directions of FIG. 1 (hereinafter referred to as front and rear surfaces), and the surfaces of the battery cell 111 and the cooling plate 112 contacting each other are lateral surfaces.

In addition, the battery system 1000 with thermal runaway stability according to the present invention preferably includes a heat conductor 300 applied to at least one of the side surfaces of the battery module 100. In this case, the heat conductor 300 may be a heat conducting filler, that is, a gap filler for heat dissipation. The heat conductor 300 may include a first heat conductor applied to the lower surface facing the upper surface of the battery module 100 and a second heat conductor applied to the upper surface of the battery module 100. However, the second heat conductor, which is applied to the upper surface of the battery module 100, may be omitted if unnecessary in an environment to which the battery system 1000 with thermal runaway stability according to the present invention is applied.

Since the support frame 200 open in the U shape is combined as a structure that protects the battery module 100, it is possible to facilitate a process of arranging the heat conductor 300 on both the upper and lower surfaces of the battery module 100 and a process of modifying the heat conductor 300. Ultimately, heat dissipation efficiency can be increased by the heat conductor 300 provided on both the upper and lower surfaces of the battery module 100.

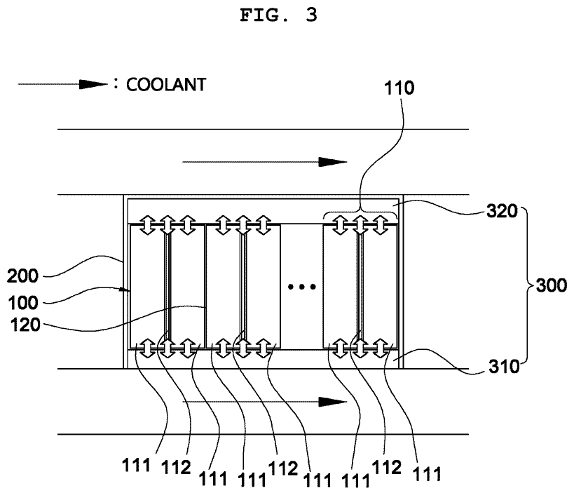

Hereinafter, the efficiency of the method of heat exchange between the battery cells 111 according to the present invention will be described with reference to FIG. 3.

By adopting the configuration as described above, heat generated in the battery cells 111 due to the cooling pipes included in each cell assembly 110 can be primarily cooled. Furthermore, even if more heat is generated in the battery cell 111, in a case where a cooling pipe through which a coolant passes is disposed outside the support frame 200 and the battery module 100, the battery module 100 can be secondarily cooled from both sides of the battery module 100 by means of the heat conductor 300 disposed on the upper and lower surfaces of the battery module 100. In addition, even if thermal runaway occurs in one cell assembly 110, heat can be prevented from being transferred to the adjacent cell assembly 110 by the heat-resistant pad 120 disposed between every two adjacent cell assemblies 110. Accordingly, the battery system 1000 with thermal runaway stability according to the present invention can secure high stability in the possibility of thermal runaway of the battery module 100.

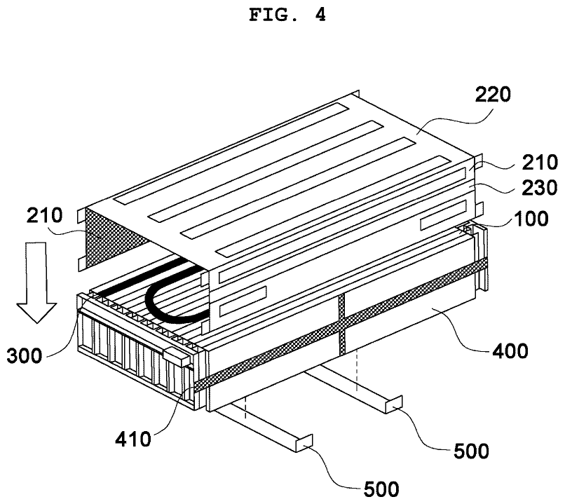

Hereinafter, a specific shape of the support frame 200 and a connection relationship of the support frame 200 with the battery module 100 according to the present invention will be described in more detail with reference to FIG. 4.

As illustrated in FIG. 4, the support frame 200 preferably includes two lateral surface coupling portions 210 coupled to surfaces of the battery module 100 perpendicular to the stacking direction, that is, the lateral surfaces of the battery module 100, and an upper surface coupling portion 220 connecting the lateral surface coupling portions 210 to each other and coupled to one surface of the battery module 100, that is, the upper surface of the battery module 100. In this case, the lateral surface coupling portions 210 and the upper surface coupling portion 220 may be jointed to each other by welding respective flat plates. Alternatively, the lateral surface coupling portions 210 and the upper surface coupling portion 220 are preferably formed integrally with each other, and may be formed by bending one flat plate.

In addition, the support frame 200 preferably includes at least one anti-swelling groove 230 protruding on the lateral surface coupling portions 210 and the upper surface coupling portion 220 in an inward direction, that is, in a direction in which the support frame 200 is brought into contact with the battery module 100. By forming the support frame 200 as described above, the swelling of the battery module 100 can be minimized, and the processes of assembling and disassembling the battery module 100 and the support frame 200 can be performed simply.

In addition, the battery system 1000 with thermal runaway stability according to the present invention preferably further includes an end plate 400 disposed between each of the lateral surface coupling portions 210 and the battery module 100. That is, the end plate 400 is preferably coupled to the lateral surface of the battery module 100. The end plate 400 may be made of an insulating material to insulate the support frame 200 and the battery module 100 from each other, and may include a wire harness 410 extending toward the front and rear surfaces of the battery module 100 in the direction in which the support frame 200 is open. It is preferable that circuits for measuring a voltage and a temperature of the battery module 100 are integrated in the wire harness 410. The wire harness 410 is preferably connected to a sensing unit 600 to be described below so that a control unit 800 may monitor a voltage state and a temperature state of the battery module 100 in real time.

In addition, the battery system 1000 with thermal runaway stability according to the present invention may further include a clamp 500 additionally supporting the coupling of the battery module 100 to the support frame 200. It is preferable that both end portions of the clamp 500 are perpendicularly bent by a predetermined length, the both end portions of the clamp 500 are fixed to the lateral surface coupling portions, respectively, and the clamp 500 is in contact with the lower surface of the battery module 100, which is a surface of the battery module 100 that does not contact the support frame 200 among the side surfaces of the battery module 100. It is preferable that the clamp 500 and the support frame 200 are coupled to each other by welding. By providing the clamp 500, the support frame 200 can support the swelling force of the battery module 100 more efficiently.

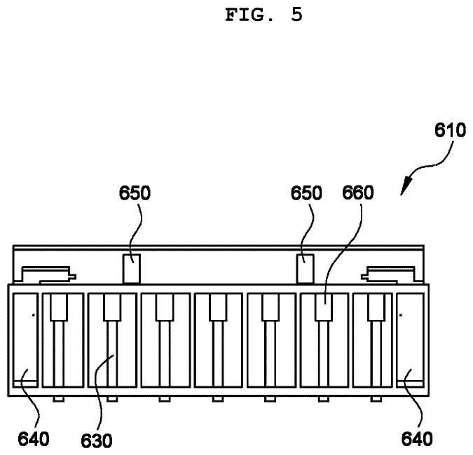

Hereinafter, the sensing unit 600 according to the present invention will be described in more detail with reference to FIGS. 5 to 8.

The battery system 1000 with thermal runaway stability according to the present invention may further include a sensing unit 600 coupled to one side and the other side of the support frame 200 to sense information of the battery module 100. More specifically, the sensing unit 600 may sense voltage information and temperature information of the battery cells 111 included in the battery module 100. In addition, the sensing unit 600 may include a front side assembly 610 coupled to a front surface of the battery module 100, which is one side of the support frame 200, with a sensing terminal 650 mounted thereon, and a rear side assembly 620 coupled to a rear surface of the battery module 100, which is the other side of the support frame 200, with a sensing terminal 650 mounted thereon. In this case, it is preferable that each of the front side assembly 610 and the rear side assembly 620 includes at least one partition wall 630 protruding toward the battery module 100, and each partition wall 630 is located between every two adjacent ones of the cell assemblies. More specifically, each partition wall 630, which is provided to prevent transition of heat, is preferably made of a material having low thermal conductivity and high heat resistance.

More specifically, as illustrated in FIG. 5, the front side assembly 610 may include +/−terminal blocks 640 connected to the electrodes of each battery cell 111 at both ends thereof, and may include a sensing PCB in which a sensing circuit is integrated. A voltage sensing connector 660 capable of sensing a voltage of each battery cell 111 may be mounted on the sensing PCB. In addition, the front side assembly 610 may include sensing terminals 650 communicating with the electrodes of each battery cell 111.

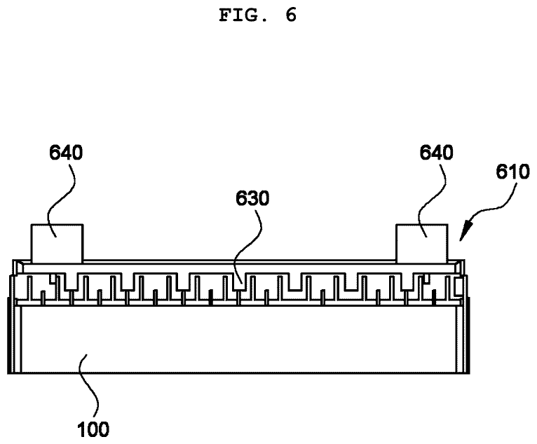

In addition, as illustrated in FIG. 6, the partition wall 630 protruding from a surface of the front side assembly 610 on a side contacting the battery module 100 may be inserted between the cell assemblies in contact with the heat-resistant pad. Since thermal runaway actually occurs from an electrode terminal side on which the battery cell 111 is supplied with power, when a large number of battery cells 111 are aggregated and stacked, it is possible to obtain significant effects in terms of thermal runaway stability as well as volume reduction of the battery module 100 by blocking the terminals of the battery cells 111 from each other using the partition wall 630 having high heat resistance therebetween.

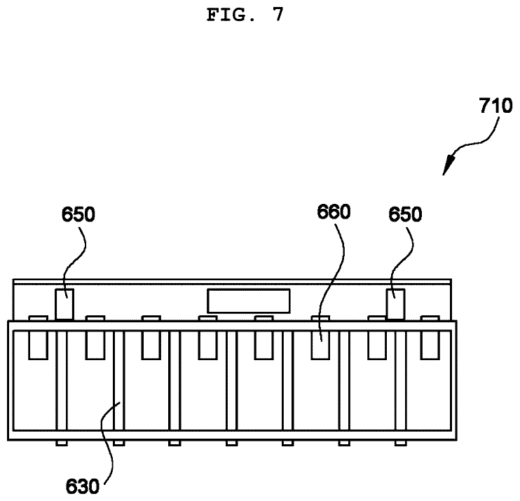

In addition, as shown in FIG. 7, the rear side assembly 620 may include a sensing PCB in which circuits for sensing a voltage and a temperature of the battery module 100 are integrated, and a voltage sensing connector 660 capable of sensing a voltage of each battery cell 111 may be mounted on the sensing PCB. In addition, the rear side assembly 620 may include sensing terminals 650 communicating with the electrodes of each battery cell 111.

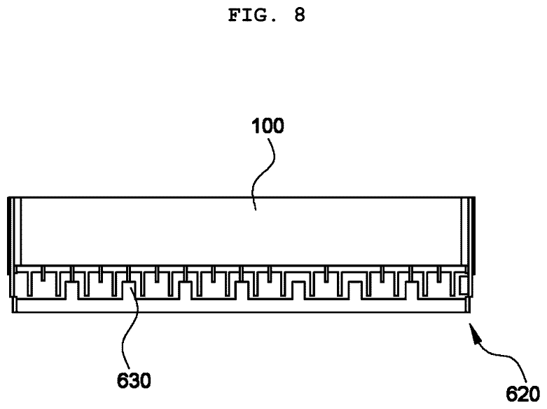

In addition, as illustrated in FIG. 8, the partition wall 630 protruding from a surface of the rear side assembly 620 on a side contacting the battery module 100 may be inserted between the cell assemblies in contact with the heat-resistant pad. Since thermal runaway actually occurs from an electrode terminal side on which the battery cell 111 is supplied with power, when a large number of battery cells 111 are aggregated and stacked, it is possible to obtain significant effects in terms of thermal runaway stability as well as volume reduction of the battery module 100 by blocking the terminals of the battery cells 111 from each other using the partition wall 630 having high heat resistance therebetween.

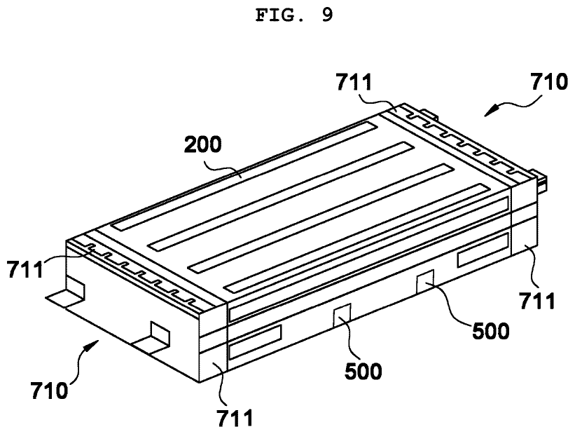

Hereinafter, a cover unit 700 according to the present invention will be described in more detail with reference to FIGS. 9 to 11.

As illustrated in FIG. 9, the battery system 1000 with thermal runaway stability according to the present invention may further include a cover unit 700 coupled to one side and the other side of the support frame to support the battery module 100, and the cover unit 700 may include a pair of cover housings 710 coupled to one side and the other side of the support frame 200, respectively. It is preferable that one end of each of the cover housings 710 is open, and the other end of each of the cover housings 710 is closed, while the cover housing 710 includes a plurality of coupling surfaces 711 surrounding one end and the other end of the cover housing 710 and coupled to the support frame 200.

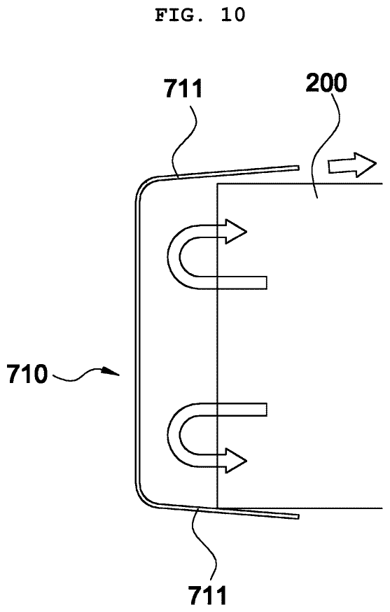

In this case, as illustrated in FIG. 10, it is preferable that at least one of the coupling surfaces 711 of the cover housing 710 is tilted in an outward direction so that the cover housing 710 has a predetermined angle of 90 degrees or more between the other end surface and the at least one of the coupling surfaces 711 thereof. As a result, gas formed when an event such as a short circuit or thermal runaway occurs inside the battery cell 111 can be discharged to the outside. In this case, the cover housing 710 may have elasticity and rigidity at predetermined levels or more, so that the tilted coupling surface 711 opens only when a pressure in an internal space formed by the cover housing 710 and the support frame 200 is greater than or equal to a predetermined level. As a result, the cover housing 710 can be sealed in such a manner that only the internal gas is discharged while dangerous elements such as flames are not discharged to the outside, thereby increasing stability inside and outside the battery system 1000 with thermal runaway stability according to the present invention.

In this case, as an example, two of the coupling surfaces 711 to be brought into contact with the side surfaces of the battery module 100 may be coupled to the support frame 200 with bolts. As a result, gas can be discharged only through the coupling surface 711 contacting the upper and lower surfaces of the battery module 100, and the cover housing 710 and the support frame 200 can be kept coupled even if the coupling surfaces 711 and the support frame 200 are separated from each other to discharge gas.

In addition, as another method for discharging gas generated in the battery module 100, the cover housing 710 preferably has at least one discharge groove formed on an outer or inner side of the coupling surface 711. In this case, it is preferable that discharge grooves are formed on surfaces coupled to the upper and lower surfaces of the battery module 100 among the coupling surfaces 711. As a result, gas formed when an event such as a short circuit or thermal runaway occurs inside the battery cell 111 may be discharged to the outside.

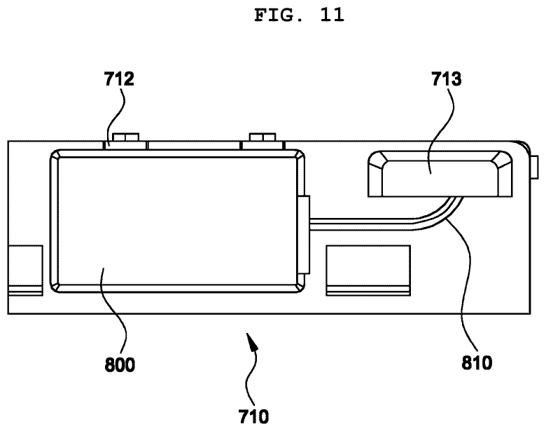

Furthermore, as illustrated in FIG. 11, it is preferable that the battery system 1000 with thermal runaway stability according to the present invention further includes a control unit 800 receiving voltage information or temperature information of the battery module 100 and controlling the battery module 100, and the cover housing 710 further includes a mounting means on an outer surface thereof to mount the control unit 800 thereon. It is preferable that the control unit 800 is mounted on one end of the mounting means, and the other end of the mounting means is coupled to the coupling surface 711 or the other end surface of the cover housing 710. In this case, the mounting means 712 and the cover housing 710 may be coupled to each other with a bolt, and the mounting means 712 may be coupled to the cover housing 710 in a detachable manner.

In addition, it is preferable that the control unit 800 includes a voltage sensing wire 810 connected to the sensing unit 600, and a communication hole 713 through which the voltage sensing wire passes is formed in the other end surface of the cover housing 710. In this case, it is preferable that the cover housing 710 in which the communication hole 713 is formed is a cover housing 710 that contacts the rear surfaces of the battery cells 111. In addition, the cover housing 710 has at least one wireless communication groove formed in the other end surface or the coupling surface 711 thereof to assist wireless communication between the control unit 800 and the sensing unit 600. By placing the control unit 800 in contact with the outer surface of the cover housing 710 as described above, a user can immediately recognize a voltage state and a temperature state of the battery module 100, and can repair the battery module 100 at any time.

The technical idea should not be interpreted as being limited to the above-described embodiments of the present invention. The present invention is applicable in a variety of ranges, and may be modified in various manners by those skilled in the art without departing from the gist of the present invention claimed. Therefore, such improvements and modifications fall within the protection scope of the present invention as long as they are obvious to those skilled in the art.

What is claimed is:

1. A battery system with thermal runaway stability, the battery system comprising:
a battery module in which one or more cell assemblies are stacked in a stacking direction, each of the cell assemblies including two battery cells and a cooling plate disposed between the two battery cells;
a support frame bent in a U shape while one side and the other side thereof are open to be coupled to three surfaces of the battery module; and
a heat conductor disposed on at least one side surface of the battery module.

2. The battery system of claim 1, wherein the support frame includes:
two lateral surface coupling portions coupled to surfaces of the battery module perpendicular to the stacking direction; and
an upper surface coupling portion connecting the lateral surface coupling portions to each other and coupled to one surface of the battery module.

3. The battery system of claim 2, wherein the heat conductor includes:
a first heat conductor disposed on a side surface of the battery module that is not in contact with the support frame; and
a second heat conductor disposed between the upper surface coupling portion and the battery module.

4. The battery system of claim 1, further comprising a heat-resistant pad disposed between every two adjacent ones of the cell assemblies.

5. The battery system of claim 1, wherein the support frame includes at least one anti-swelling groove in an inward direction on each surface thereof.

6. The battery system of claim 2, further comprising an end plate disposed between each of the lateral surface coupling portions and the battery module.

7. The battery system of claim 6, wherein the end plate includes a wire harness extending in a direction in which the support frame is open, and
circuits measuring a voltage and a temperature of the battery module are integrated in the wire harness.

8. The battery system of claim 2, further comprising a clamp additionally supporting the coupling of the battery module to the support frame,
wherein both end portions of the clamp are perpendicularly bent by a predetermined length, and the both end portions of the clamp are fixed to the lateral surface coupling portions, respectively, and
the clamp is in contact with a side surface of the battery module that is not in contact with the support frame.

9. The battery system of claim 1, further comprising a sensing unit coupled to the one side and the other side of the support frame to sense information of the battery module,
wherein the sensing unit includes:
a front side assembly coupled to the one side of the support frame, with a sensing terminal mounted thereon; and
a rear side assembly coupled to the other side of the support frame, with another sensing terminal mounted thereon,
each of the front side assembly and the rear side assembly includes at least one partition wall protruding toward the battery module, and
the partition wall is located between every two adjacent ones of the cell assemblies.

10. The battery system of claim 1, further comprising a cover unit coupled to one side and the other side of the support frame to support the battery module,
wherein the cover unit includes a pair of cover housings coupled to the one side and the other side of the support frame,
one end of each of the cover housings is open, and the other end of each of the cover housings is closed, and
the cover housing includes a plurality of coupling surfaces surrounding one end and the other end of the cover housing and coupled to the support frame.

11. The battery system of claim 10, wherein at least one of the coupling surfaces of the cover housing is tilted in an outward direction so that the cover housing has a predetermined angle of 90 degrees or more between the other end and the at least one of the coupling surfaces thereof.

12. The battery system of claim 10, wherein the cover housing has at least one discharge groove on an outer side of each of the coupling surfaces.

13. The battery system of claim 10, wherein the cover housing has at least one discharge groove on an inner side of each of the coupling surfaces.

14. The battery system of claim 10, further comprising a controller receiving voltage information or temperature information of the battery module and controlling the battery module,
wherein the cover housing further includes a mounting means on an outer surface on which the controller is disposed.

15. The battery system of claim 14, wherein the controller includes a voltage sensing wire connected to a sensing unit, and
a communication hole through which the voltage sensing wire passes is disposed in the other end surface of the cover housing.

16. The battery system of claim 14, wherein the cover housing has at least one wireless communication groove in the other end surface or one of the coupling surfaces thereof to assist wireless communication between the controller and the sensing unit.
